(19) United States
(12) Patent Application Publication
(10) Pub. No.: US 2004/0143533 A1
(43) Pub. Date: Jul. 22, 2004

(54) Computerised apparatus and methods of converting a portfolio strategy into a set of tactics

(76) Inventors: Christopher William Preist, Bristol (GB); Michael Child, Bath (GB); Marco Casassa Mont, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/474,069

(22) PCT Filed: Apr. 11, 2002
(86) PCT No.: PCT/GB02/01679

(30) Foreign Application Priority Data
Apr. 11, 2001 (GB) 0109074.5

(51) Int. Cl. G06F 17/60

(52) U.S. Cl. 705/36

(57) ABSTRACT

There is provided computerised apparatus and a method of converting a financial portfolio strategy into a set of tactics. The apparatus comprises: a stock data store for storing stock data relating to the stock held in a financial portfolio and to classification attributes of the stock; a current portfolio module operable to access the data stored in the stock data store, and operable to classify the stocks held in the financial portfolio from the stock data to generate classification data relating to the classification of the stocks for user display; a new portfolio module operable to receive and store new portfolio data relating to a desired new financial portfolio; a stock evaluation module for storing valuation data relating to an assessment of stocks; a tactic generator engine operable to access the stock data stored in the stock data store, the new portfolio data stored in the new portfolio module, the valuation data stored in the stock evaluation module, and current market data from financial markets, and operable to perform tactic generating functions on the basis of the stock data, the new portfolio data, the valuation data and current market data to output a set of tactics.

The present invention relates a computerised system for converting a portfolio strategy into a set of tactics, and in particular to a computerised apparatus for generating a set of tactics from a financial portfolio strategy and method therefor.

Fund Managers must make decisions about the strategy they will use to maximise the value of the financial portfolios under their control, and specifically which tactics to employ to implement those strategies. Strategies are typically decisions such as what percentage of a financial portfolio is to be placed in long-term stocks, short-term stocks, and in blue-chip companies, for example. Tactics are the actions to be undertaken, such as which stocks to buy and sell to create the required balance in the financial portfolio. The tactics decided by the Fund Managers are passed to traders who make the actual purchases or sales.

A set of strategies can be executed through a variety of different ways, and the time; differential between the Fund Manager's choice of purchase decisions and the actual making of purchases may result in the use of inferior tactics. If a crossing network is used, with limited stock availability, this effect can be exacerbated, with opportunities being missed. Therefore there is a need for a computerised system that is able to access the current market situation and propose the best tactics to use at that time, either for manual or automatic execution, for maximising the value of the fund portfolio.

Microsoft™ Excel™ Solver™ is software that may be used for portfolio optimisation, i.e. the construction of efficient portfolios of securities. However, the process employed is based on measuring co-bearings between each pair of stocks contained in the portfolio, and involves the user inputting detailed information about specific stocks and shares, such as projected rates of return, their riskiness as measured by the variance (or standard deviation) of price changes and the covariance (or correlation) between difference securities. The software determines the best allocation of funds to each security. However, Microsoft™ Excel™ Solver™ clearly does not address the above-mentioned problems, nor does it fulfil the described need as it is not able to accept an input of a financial strategy and generate a set of tactics therefrom.

The present invention seeks to mitigate the above-mentioned problems and needs, and to provide a computerised apparatus for converting a portfolio strategy into a set of tactics.

According to the present invention there is provided a computerised apparatus for converting a financial portfolio strategy into a set of tactics, said strategy and tactics relating to the conversion of a financial portfolio comprising stocks into a desired new financial portfolio comprising stocks, said apparatus comprising: a stock data store for storing stock data relating to the stock held in said financial portfolio and to classification attributes of said stock; a current portfolio module operable to access the data stored in the stock data store, and operable to classify the stocks held in said financial portfolio from the stock data to generate classification data relating to the classification of the stocks for user display; a new portfolio module operable to receive and store new portfolio data relating to a desired new financial portfolio; a stock evaluation module for storing valuation data relating to an assessment of stocks; a tactic generator engine operable to access the stock data stored in the stock data store, the new portfolio data stored in the new portfolio module, the valuation data stored in the stock evaluation module, and current market data from financial markets, and operable to perform tactic generating functions on the basis of the stock data, the new portfolio data, the valuation data and current market data to output a set of tactics.

According to a second aspect there is provided a computerised apparatus for converting a financial portfolio strategy into a set of tactics, said strategy and tactics relating to the conversion of a financial portfolio comprising stocks into a desired new financial portfolio comprising stocks, said apparatus comprising: a stock data store for storing stock data relating to the stock held in said financial portfolio and to classification attributes of said stock and stock other than that held in the financial portfolio; a current portfolio module operable to access the data stored in the stock data store, and operable to classify the stocks held in said financial portfolio from the stock data to generate classification data relating to the classification of the stocks for user display; a new portfolio module operable to receive and store new portfolio data relating to a desired new financial portfolio; a stock evaluation module for storing valuation data relating to an assessment of stocks; a tactic generator engine operable to access the stock data stored in the stock data store, the new portfolio data stored in the new portfolio module, the valuation data stored in the stock evaluation module, and current market data from financial markets, and operable to perform tactic generating functions to label stock data relating to at least one stock with a tactic tag on the basis of the stock data, the new portfolio data, the valuation data and current market data to output a set of tactics, the tactic tag being an identifier of the tactic to be employed in relation to that stock.

According to a third aspect there is provided a computerised apparatus for converting a financial portfolio strategy into a set of tactics, said strategy and tactics relating to the conversion of a financial portfolio comprising stocks into a desired new financial portfolio comprising stocks, said apparatus comprising: a holdings data store for storing holdings data relating to the number and the types of stock held in said financial portfolio; a classification data store for storing the classification attributes of the stock; a current portfolio module operable to access the data stored in the stock data store, and operable to classify the stocks held in said financial portfolio from the stock data to generate classification data relating to the classification of the stocks for user display; a new portfolio module operable to receive and store new portfolio data relating to a desired new financial portfolio; a stock evaluation module for storing valuation data relating to an assessment of stocks; a tactic generator engine operable to access the stock data stored in the stock data store, the new portfolio data stored in the new portfolio module, the valuation data stored in the stock evaluation module, and current market data from financial markets, and operable to perform tactic generating functions on the basis of the stock data, the new portfolio data, the valuation data and current market data to output a set of tactics.

According to a fourth aspect there is provided a method of converting a financial portfolio strategy into a set of tactics using computerised apparatus, said strategy and tactics relating to the conversion of a financial portfolio comprising stocks into a desired new financial portfolio comprising stocks, said method comprising: receiving new portfolio data relating to said desired new financial portfolio and valuation data relating to an assessment of stocks; accessing a financial market for current market data relating to the current performance and availability of stocks being traded in the financial market; and generating a set of tactics for achieving said d sired new financial portfolio on the basis of stock data relating to the stock held in said financial portfolio and classification attributes of the stock, the new portfolio data, the valuation data and the current market data.

According to a fifth aspect there is provided a method of converting a financial portfolio strategy into a set of tactics using computerised apparatus, said strategy and tactics relating to the conversion of a financial portfolio comprising stocks into a desired new financial portfolio comprising stocks, said method comprising: retrieving stock data relating to the stock held in said financial portfolio and classification attributes of the stock from a stock data store; classifying stocks held in the financial portfolio using the stock data to generate classification data relating to the classification of the stocks for user display; receiving new portfolio data relating to said desired new financial portfolio and valuation data relating to an assessment of stocks; accessing a financial market for current market data relating to the current performance and availability of stocks being traded in the financial market; and generating a set of tactics for achieving said desired new financial portfolio on the basis of the stock data, the new portfolio data, the valuation data and the current market data.

According to a sixth aspect there is provided a computer readable storage medium storing instructions that, when executed by a computer, cause the computer to perform a method of converting a financial portfolio strategy into a set of tactics according to the fourth or fifth aspect.

Other aspects and features of the present invention will become apparent to those ordinarily skilled in the art upon review of the following description of specific embodiments of the invention in conjunction with the accompanying figures.

Embodiments of the invention will now be described by way of example only, with reference to the drawings in which:

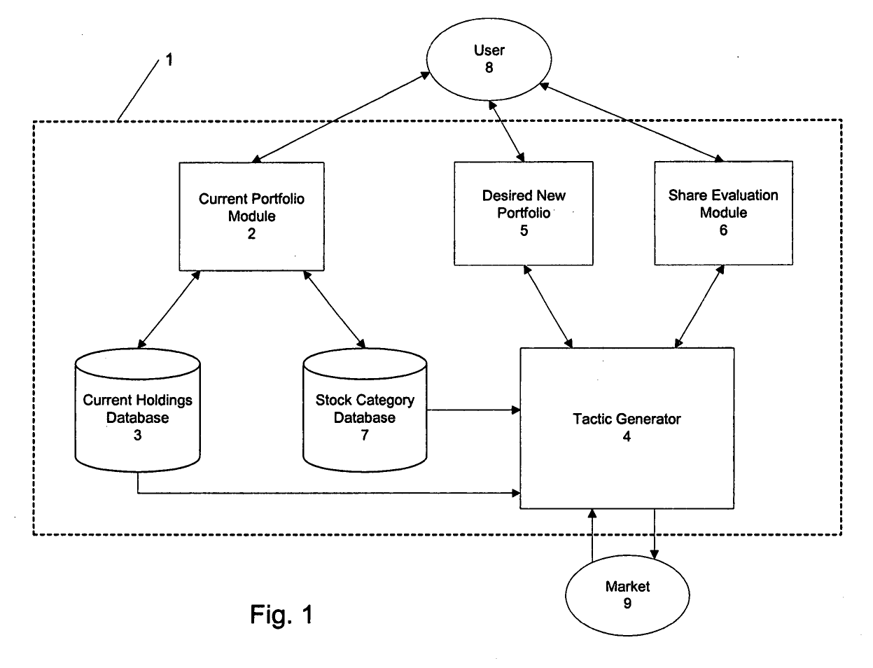

FIG. 1 is a schematic block diagram of a computerised system according to a preferred embodiment of the present invention; and

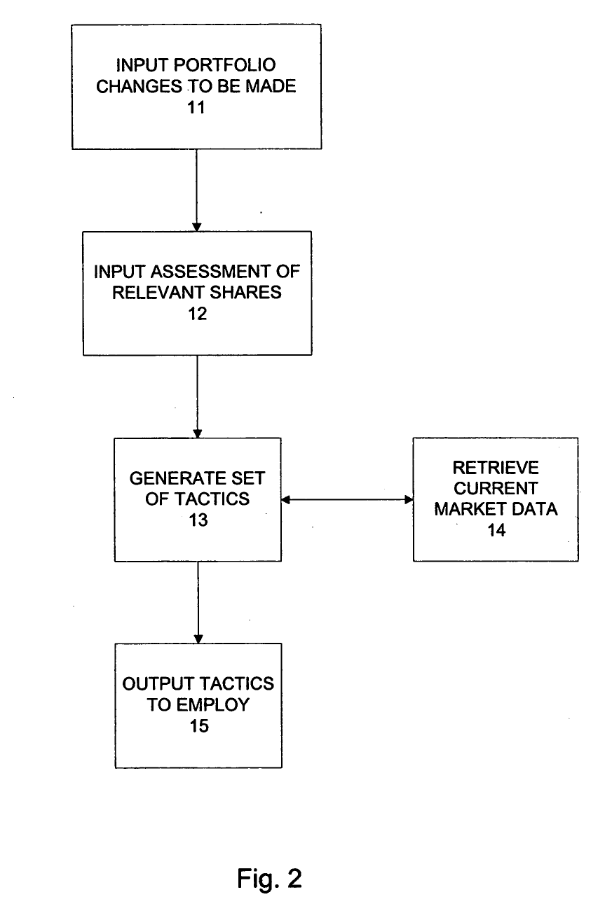

FIG. 2 is a simplified flow diagram of the main processes involved according to an embodiment of the invention.

With reference to the figures, especially FIG. 2, a preferred embodiment will now be described which evaluates a set of tactics based on a Fund Manager's portfolio strategy and the current market situation. A user 1, usually the Fund Manager, enters data about the current portfolio and desired portfolio changes 11. The user will also enter, or update, an assessment of relevant shares 12. The system will then generate a set of tactics 13 in real time that should be actioned. This is possible because at the time when the tactics are to be generated, the system views the current state of the market 14, i.e. prices and in the case of a crossing network availability, and outputs appropriate tactics to be employed 15.

As illustrated in FIG. 1, a computerised system 1 of the preferred embodiment comprises a current portfolio module 2 connected to a current holdings database 3, a tactic generator 4 connected to a desired new portfolio module 5, to a share evaluation module 6 and to a stock category database 7. The current holdings database 3 stores information relating to the number and type of shares held in the financial portfolio managed by the user 8. This information may be input by the user, or other personnel working with the user. The stock category database 7 holds information about each particular stock which identifies the attributes each stock has such as company classification, for example hi-tech, blue chip, UK, US. This information is input to the current portfolio module 2 which uses this classification information along with the information stored in the current holdings database 3 to categorise the existing shareholdings, and to present the user with a summary of the current holdings within a financial portfolio in terms of its breakdown according to the percentage held in the different classifications of the holdings. The summary presented to the user allows the user to take a global view of the holdings within the financial portfolio, and to see at a glance whether the financial portfolio is balanced in the way that the user wants. The user 8 is then able to identify the new portfolio balance they wish for, and enter this information into the system 1 via a user input interface. The data relating to the new portfolio balance is stored in the new portfolio module 5 from where the data may be accessed by the tactic generator 4. The user may also enter constraints such as the maximum percentage required in any one type of stock or share, as well as the share valuations into the system.

To rebalance the financial portfolio, the user enters statements relating to the changes to be made to the holdings comprising the financial portfolio. The statements may be in the form of percentage changes to be made to the holdings, or the new percentage that the changed holdings should be, or in any other convenient form.

All the information input by the user 8 relating to the new portfolio balance is stored in the desired new portfolio module 5.

The share evaluation module 6 stores share valuation data relating to information that the user has input regarding their value or utility for particular stocks or shares based on different projected prices. The share valuation data is a measure of how keen the user would be to purchase or sell each share in different price bands. This information may be requested in the form of a current rating. The same stocks or shares may have different ratings, one for the short-term, and another for the long-term. Whilst this rating information may be determined by the Fund Manager as a user, it instead may be determined and input into the computerised system 1 by a financial analyst who works in collaboration with the Fund Manager. Unlike many commodities, it is not necessarily the case that the higher the price, the less willing a buyer will be to make a purchase. If the user 8 is aiming for short term profits, they may be more likely to purchase a stock which has recently increased in price. Instead of just holding information relating to the shares that the user is interested in, the share evaluation module 6 may hold information relating to any share that the user is potentially interested in, or even evaluation data obtained from the internet or other computerised network using an automated process.

The tactic generator 4 accesses the information stored in the desired new portfolio store 5, and cross-correlates it with the current market data obtained by accessing a financial market 9, for example the London Stock Exchange, to output a set of proposed tactics—specifically, proposed buy and/or sell decisions. It does this by assessing the proposed changes to the portfolio by accessing data held in the current portfolio module 2 and the desired new portfolio module 5, and labelling any share in a sector which is over the required percentage as a possible sell, and any share in a sector (including those currently not held at all) which is under the required percentage as a possible buy. The tactic generator 4 then associates all labelled shares with a rating by accessing the share valuation data stored in the share evaluation module 6 and current market data, and by using this data to determine a rating for each share. In the case of a crossing network, any share which cannot currently be bought and/or sold in the market 9 is unlabelled and ignored.

For each category, the tactic generator 4 orders labelled shares according to a ‘best first’ order. Ordering according to a ‘best first’ order is where shares are ordered with the lowest rating first, these shares being the ones which are to be sold first. If all categories of shares in the strategy are disjointed, then it is straightforward to generate possible sets of tactics in the ‘best first’ order. For each category, which is over the required percentage, the holdings are listed in order of strongest sell until the required percentage adjustment is reached. For each category which is under the required percentage, holdings similarly are listed in order of strongest buy until the required percentage adjustment is reached. When this process is completed, if any ‘strong sells’ listed in any category remain, these are used as sells, and compensatory buys are chosen to share value from the category. This process is repeated if any category contains ‘sells’, and ‘strong buys’ remain available. If categories overlap (for example, a foreign blue-chip share may be categorised as ‘foreign’ and ‘blue chip’ then the algorithm employed by the tactic generator is more complex, and drives the tactic generator 4 to select a set of shares for actioning which results in the correct number of shares being bought or sold depending on the net deficit.

An example of a preferred implementation of the computerised system follows hereafter.

The current holdings database 3 and the stock category database 7 may be implemented by adopting a PROLOG/relational database format. For example, in the current holdings database 3 the following entries:

holding (hwp,1000)

holding (hbos,10000)

holding (sunw,10000)

indicate that the current holdings within the financial portfolio are 10,000 Hewlett Packard shares, 10,000 Bank of Scotland shares, and 10,000 Sun shares.

The stock category database 7 may include classification of stocks that do not currently constitute the current holdings database 3, but which the Fund Manager may want to purchase in the future. An example of the entries for classified stocks are:

country (hwp,usa)

country (sunw,usa)

country (amexpr,usa)

country (bankam,usa)

country (hbos,finance)

country (Halifax,finance)

sector (hwp,hi-tech)

sector (sunw,hi-tech)

sector(arm_holdings,hi-tech)

sector (amexpr,finance)

sector (bankam,finance)

sector (hbos,finance)

sector (halifax,finance)

whereby country and industrial sector classification entries are included for American Express (amexpr), Bank of America (bankam), Arm Holdings (arm_holdings), and Halifax (Halifax) stocks in addition to the three stocks given in the previous example which currently constitute the financial portfolio.

Instead of using a PROLOG/relational database format, other equally applicable formats of which the skilled person would be aware may be used for the two databases.

In order for the current portfolio module 2 to display the relative percentages of different categories of stock in terms of financial value, the current portfolio module 2 accesses the current market prices via the tactic generator 4. Thus, continuing with the example given above, the current portfolio module 2 displays the following information:

Market prices: hwp−£20; hbos−£10; sunw−£10

Country:

US: 75% UK: 25%

Sector:

Hi Tech: 75% Financial: 25%

which provides a breakdown of the contents of the financial portfolio according to the classification utilised in the stock category database 7, in this example by country and industrial sector. It will be appreciated by the skilled person that any useful classification could be used to display a breakdown of the holdings in the financial portfolio, depending on the Fund Manager's/user's needs.

The desired new portfolio module 5 provides the user with an interface through which the new, relative percentages of desired stock according to classification can be entered. Various possible input devices, such as sliders, pie charts and the like, would be known to the skilled person and may be used to enable the entering of the desired new portfolio depending on user choice during design of the system.

Preferably, a simple text based approach may also be utilised, whereby the user enters the new percentages of the desired stocks into text boxes displayed in a web-based form. Constraints of the system ensure that the percentages add up to 100. For example, if the user (Fund Manager) decides to alter the balance of stock away from the US and hi-tech sectors towards the UK and financial sectors, the user may enter:

Country:

US: 50% UK: 50%

Sector

Hi Tech: 50% Financial: 50%

Optionally, the computerised system can allow ranges of percentage, rather than a fixed percentage to be entered, for example UK: 20-40%.

For each share in the stock category database 7 which the user may possibly wish to buy, information is entered into the share evaluation module 6 relating to the value of each share or the utility of each share based on projected prices for the near future. The share evaluation information for Hewlett Packard (hwp) shares given in the form of ratings, for example, maybe:

| Price (£) | Rating |
|---|---|
| 0-8 | Strong Sell |
| 8-10 | Sell |
| 10-14 | Hold |
| 14-20 | Buy |
| 20-30 | Strong Buy |
| 30-40 | Buy |
| 40-60 | Hold |
| 60+ | Sell |

When the stock is at a given price it is assigned a rating and this procedure is conducted for all such stock through the share evaluation module 6.

The tactic generator for accesses to financial markets did determine the current stock prices, and uses the data stored in the share evaluation module 6 to assign a rating for each labelled share in the current financial portfolio, and in the desired new portfolio. For example, assume that the shares referred to previously are evaluated and assigned a rating as follows:

Strong Buy: ARM holdings

Buy: HWP, Halifax

Hold: HBOS, Amexpr, BankAm

S II: Sunw

Strong Sell: none

The tactic generator 4 utilises an algorithm for optimal portfolio allocation to generate tactics for rebalancing the financial portfolio, mainly sets of buy and sell proposals. This algorithm will be described in more detail later. For example, given the inputs to the desired new portfolio module 5 given above, the algorithm may generate the following tactics:

sell (sunw, 10000)

buy (Halifax, 10000)

Although the sells are specified in terms of share numbers whilst buys are specified in terms of money, the buy and sell proposals may be specified in terms of the number of shares or cost, or any combination thereof depending on user preference. When the generated tactics are executed, they result in the desired new portfolio balance being achieved.

An example of an algorithm for optimal portfolio allocation which may be used for generating tactics or rebalancing the financial portfolio, is described below. The optimal portfolio is defined as one maximizing the rating value of each of the shares that compose it, multiplied by the holdings of each share; plus the rating of cash times cash quantity, subject to the following constraints:

Single share constraint

[Max single share] A single share holding cannot amount to more than a specified percentage of the portfolio value.

Category constraints

[Category max] Holdings of shares in a single categories cannot amount to more than a specified percentage of the portfolio value.

[Category min] Holdings of shares in a single categories cannot amount to less than a specified percentage of the portfolio value.

Cash constraints

[Cash max] Cash cannot amount to more than a specified percentage of the portfolio value.

[Cash min] Cash cannot amount to more than a specified percentage of the portfolio value.

Commission constraint

[Commission] Maximum commission paid cannot amount to more than a specified quantity.

It is important to note that the current price of a particular share is not an input to the problem. The share ratings are set so as to subsume information about the current price of the share.

Definitions of the input values for the algorithm are as follows.

Categories—categories of shares are costed by sector, for example geographical sector, industrial sector, and for each sector categories are defined, such as US, Europe and Asia Pacific for the geographical sector.

Shares—is a set of shares that potentially can be part of the optimal portfolio. For each share a rating value is given and is allocated a category for each sector.

Cash—cash is rated with a value that expresses its desirability with respect to the shares.

Current Portfolio—is defined in terms of the held quantity for each share and the held quantity of cash.

Commissions—commission to buy and sell are expressed as a percentage over the transaction value, and the maximum paid cannot amount to more than a specified quantity.

The output value from the algorithm is the quantity of each share to be bought and sold.

The definitions of the input and output values are utilised to define the optimal portfolio problem as a linear programming problem, as in the example as given below. The notation used is the algebraic modelling language AMPL [ ].

```
# -----------------------------------------------------------------------------------
# PARAMETERS
# -----------------------------------------------------------------------------------
# -----------------------------------------------------------------------------------
# a set of shares that can potentially be part of the
# optimal portfolio
# -----------------------------------------------------------------------------------
set SHARES ordered;
# -----------------------------------------------------------------------------------
# shares categories, clustered by sectors
set CATEGORIES ordered;
# rating of shares and holdings in the current portfolio
# -----------------------------------------------------------------------------------
param rating {SHARES} >= 0, <= 5;
param holdings {SHARES} >= 0, default 0;
# -----------------------------------------------------------------------------------
# constraints over the minimum and maximum percentage
# of shares of a same category
# -----------------------------------------------------------------------------------
param min_category {CATEGORIES} >= 0, <= 1, default 0;
param max_category {i in CATEGORIES} >= min_category[i], <= 1, default 1;
# -----------------------------------------------------------------------------------
# association of shares to categories
# the association parameter is 1 if a share belongs to a
# category, 0 otherwise
# -----------------------------------------------------------------------------------
param association {CATEGORIES, SHARES} integer >= 0, <= 1, default 0;
# -----------------------------------------------------------------------------------
# other parameters to express current total holdings,
# cash holdings, cash rating, minimum and maximum
# admissible percentage of cash in the optimal portfolio,
# maximum admissible percentage for a single share in the
# optimal portfolio, commission rate and maximum
# acceptable commission
# -----------------------------------------------------------------------------------
param total_holdings >= 0;
param cash_holdings >= 0;
param cash_rating >= 0, <= 5;
param min_cash >= 0, <= 1;
param max_cash >= 0, <= 1;
param max_single_share >= 0, <= 1;
param commission >= 0, <= 1;
param max_commission >= 0;
# -----------------------------------------------------------------------------------
# VARIABLES
# -----------------------------------------------------------------------------------
# -----------------------------------------------------------------------------------
# shares to be bought and sold to compose the optimal
# portfolio
# -----------------------------------------------------------------------------------
var Buy {SHARES} >= 0, <= max_single_share * total_holdings;
var Sell {SHARES} >= 0, <= max_single_share * total_holdings;
# -----------------------------------------------------------------------------------
# OBJECTIVE
# maximize the total rating of the new portfolio
# that is the sum over all the newly held shares of the share
# rating, added to the rating for newly held cash
# Newly held shares are computed through the formula
# holdings + Buy − Sell
# Newly held cash is
# cash_holdings − sum Buy + sum Sell − commission paid
# Commission paid is
# commission * sum (Buy + Sell)
# Holdings are taken off the objective function, because
# they are constant
# -----------------------------------------------------------------------------------
maximize Total_Rating: sum {j in SHARES} ( (rating[j] − (1 + commission) *
cash_rating ) * Buy [j] + ( − rating [j] + (1 − commission)
* cash_rating ) * Sell [j] );
# -----------------------------------------------------------------------------------
# CATEGORY_MIN_CONSTRAINT
# the sum of the newly held shares for a certain category
# must not be less than the minimum allowed for the
# category
# Newly held shares are computed through the formula
# holdings + Buy − Sell
# The min_category percentage is multiplied by the new
# total holdings, i.e. the current total holdings less
# commission paid:
# total_holdings − commission * sum (Buy + Sell)
# -----------------------------------------------------------------------------------
subject to Category_min_constraint {i in CATEGORIES}:
    sum {j in SHARES} association [i, j] * (holdings [j] + Buy [j] − Sell [j] >=
min category [i] * (total_holdings − commission * sum {j in SHARES} (Buy[j] +
Sell [j] ) );
# -----------------------------------------------------------------------------------
# CATEGORY_MAX_CONSTRAINT
# analogous to CATEGORY_MIN_CONSRAINT
# -----------------------------------------------------------------------------------
subject to Category_max_constraint {i in CATEGORIES}:
    sum {j in SHARES} association [i, j] *(holdings [j] + Buy [j] − Sell [j]) <=
max_category [i] *(total_holdings − commission * sum {j in SHARES} (Buy [j] +
Sell [j] ) );
# -----------------------------------------------------------------------------------
# CASH_MIN_CONSTRAINT
# newly held cash must not be less than the minimum
# allowed.
# Newly held cash is
# cash_holdings − sum Buy + sum Sell − commission paid
# Commission paid is
# commission * sum (Buy + Sell)
# The min_cash percentage is multiplied by the new
# total holdings, i.e. the current total holdings less
# commission paid:
# total_holdings − commission * sum (Buy + Sell)
# -----------------------------------------------------------------------------------
subject to Cash_min_constraint:
    cash_holdings − (1 + commission) * sum {j in SHARES} Buy [j] + (1 −
commission) * sum {j in SHARES} Sell [j] >= min_cash * (total_holdings −
commission * sum {j in SHARES} (Buy [j] + Sell [j] ) );
# -----------------------------------------------------------------------------------
# CASH_MAX_CONSTRAINT
# analogous to CASH_MIN_CONSTRAINT
# -----------------------------------------------------------------------------------
subject to Cash_max_constraint:
    cash_holdings − (1 + commission) * sum {j in SHARES} Buy [j] + (1 −
commission) * sum {j in SHARES} Sell [j] <= max_cash * (total_holdings −
commission * sum {j in SHARES} (Buy [j] + Sell [j] ) );
# -----------------------------------------------------------------------------------
# COMMISSION_CONSTRAINT
# commission paid must not be greater than the specified
# maximum commission
# -----------------------------------------------------------------------------------
subject to Commission_constraint:
    commission * sum {j in SHARES} (Buy [j] + Sell [j] <= max_commission;
# -----------------------------------------------------------------------------------
# NOT_SELLING_SHORT_CONSTRAINT
# quantity of sold shares must not be greater than
# the current holdings
# -----------------------------------------------------------------------------------
subject to Not_selling_short_constraint {j in SHARES}:
    Sell [j] <= holdings [j];
```

An example of the AMPL definition of the data set used with the linear programming problem described above is as follows:

| Param: SHARES: | rating | holdings: = |
|---|---|---|
| “HP” | 1.84 | 100 |
| “IBM” | 4.19 | 250 |
| “Marks and Spencer” | .84 | 312 |
| “FIAT” | 3.44 | 25 |
| “Toyota” | 2.29 | . |
| “General Motors” | 2.77 | . |
| “Citroen” | 4.29 | 13 |
| “Wal Mart” | .60 | . |
| “Bull” | .72 | . |
| “NEC” | 2.08 | .; |

param total_holdings:=700;

param cash_holdings:=250;

param cash_rating:=0.5;

param min_cash:=0.25;

param max_cash:=0.50;

param max_single_share:=0.50;

| param: CATEGORIES: | min_category | max_cateogory: = |
|---|---|---|
| Computers | .40 | .50 |
| Automotive | .05 | .15 |
| Retail | .40 | .60 |
| US | .40 | .50 |
| Europe | .20 | .60 |
| Far East | . | .05; |

| param | | | | | | |
|---|---|---|---|---|---|---|
| association | | | | | | |
| (tr): | Computers | Automotive | Retail | US | Europe | FarEast: = |
| “HP” | 1 | . | . | 1 | . | . |
| “IBM” | 1 | . | . | 1 | . | . |
| “Marks | . | . | 1 | . | 1 | . |
| and | | | | | | |
| Spencer” | | | | | | |
| “FIAT” | . | 1 | . | . | 1 | . |
| “Toyota” | 1 | . | . | . | . | 1 |
| “General | . | 1 | . | 1 | . | . |
| Motors” | | | | | | |
| “Citroen” | . | 1 | . | . | 1 | . |
| “Wal Mart” | . | . | 1 | 1 | . | . |
| “Bull” | 1 | . | . | . | 1 | . |
| “NEC” | 1 | . | . | . | . | 1; |

param commission:=0.01;

param max_commission:=5;

The set of shares is composed of shares belonging to the categories of geography and industry sector, whereby the geographical categories are US, Europe and Far East, and the industry categories are computer, automotive and retail. The shares are associated to the categories through the association matrix. A rating value is assigned to each share and the current portfolio is expressed in terms of the holdings. Other data of the problem are the maximum and minimum percentage of cash, the maximum and minimum percentage of shares of a certain category, and the maximum allowed percentage of the single share. A rating value is given for cash to. Finally, the percentage cost of commission and the maximum commission to pay are expressed.

To train the proposed system a ‘best first’ version of Reiter's Diagnosis Hitting Set algorithms or Peng-Reggia's Set Covering algorithms may be utilised in the proposed system to provide a good initial start. Once a set of tactics are generated, they are output and may fail. Rather than using deliberative planning techniques, the best approach is for the user to respond reactively, ignore all previous working, update the portfolio data based on successful buy/sells, and generate a new set of tactics which move the portfolio towards the required balance of categories.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier be any entity or device capable of carrying the program.

For example, the carrier may comprise a storage medium, such as ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

Although the invention has been shown and described with respect to a best mode embodiment thereof, it should be understood by those skilled in the art that the foregoing and various other, changes, omissions and additions in the form and detail thereof may be made therein without departing from the scope of the invention as claimed.

1. A computerised apparatus for converting a financial portfolio strategy into a set of tactics, said strategy and tactics relating to the conversion of a financial portfolio comprising stocks into a desired new financial portfolio comprising stocks, said apparatus comprising:
a stock data store for storing stock data relating to the stock held in said financial portfolio and to classification attributes of said stock;
a current portfolio module operable to access the data stored in the stock data store, and operable to classify the stocks held in said financial portfolio from the stock data to generate classification data relating to the classification of the stocks for user display;
a new portfolio module operable to receive and store new portfolio data relating to a desired new financial portfolio;
a stock evaluation module for storing valuation data relating to an assessment of stocks;
a tactic generator engine operable to access the stock data stored in the stock data store, the new portfolio data stored in the new portfolio module, the valuation data stored in the stock evaluation module, and current market data from financial markets, and operable to perform tactic generating functions on the basis of the stock data, the new portfolio data, the valuation data and current market data to output a set of tactics.

2. Apparatus according to claim 1, wherein the tactic generator is operable to label stock data relating to at least one stock with a tactic tag determined by tactic generating functions, the tactic tag being an identifier of the tactic to be employed in relation to that stock.

3. Apparatus according to claim 1, wherein the stock data store is operable to store data relating to the classification attributes of stock other than that held in the financial portfolio.

4. Apparatus according to claim 1, wherein the stock data store comprises:
a holdings data store for storing holdings data relating to the number and the types of stock held in said financial portfolio; and
a classification data store for storing the classification attributes of the stock.

5. Apparatus according to claim 1, wherein the new portfolio module is associated with an interface through which a user enters the new portfolio data.

6. Apparatus according to claim 3, wherein the new portfolio module is associated with an interface through which a user enters the new portfolio data.

7. A computerised apparatus for converting a financial portfolio strategy into a set of tactics, said strategy and tactics relating to the conversion of a financial portfolio comprising stocks into a desired new financial portfolio comprising stocks, said apparatus comprising:
a stock data store for storing stock data relating to the stock held in said financial portfolio and to classification attributes of said stock and stock other than that held in the financial portfolio;
a current portfolio module operable to access the data stored in the stock data store, and operable to classify the stocks held in said financial portfolio from the stock data to generate classification data relating to the classification of the stocks for user display;
a new portfolio module operable to receive and store new portfolio data relating to a desired new financial portfolio;
a stock evaluation module for storing valuation data relating to an assessment of stocks;
a tactic generator engine operable to access the stock data stored in the stock data store, the new portfolio data stored in the new portfolio module, the valuation data stored in the stock evaluation module, and current market data from financial markets, and operable to perform tactic generating functions to label stock data relating to at least one stock with a tactic tag on the basis of the stock data, the new portfolio data, the valuation data and current market data to output a set of tactics, the tactic tag being an identifier of the tactic to be employed in relation to that stock.

8. Apparatus according to claim 7, wherein the stock data store comprises:
a holdings data store for storing holdings data relating to the number and the types of stock held in said financial portfolio; and
a classification data store for storing the classification attributes of the stock.

9. Apparatus according to claim 7, wherein the new portfolio module is associated with an interface through which a user enters the new portfolio data.

10. Apparatus according to claim 8, wherein the new portfolio module is associated with an interface through which a user enters the new portfolio data.

11. A computerised apparatus for converting a financial portfolio strategy into a set of tactics, said strategy and tactics relating to the conversion of a financial portfolio comprising stocks into a desired new financial portfolio comprising stocks, said apparatus comprising:
a holdings data store for storing holdings data relating to the number and the types of stock held in said financial portfolio;
a classification data store for storing the classification attributes of the stock;
a current portfolio module operable to access the data stored in the stock data store, and operable to classify the stocks held in said financial portfolio from the stock data to generate classification data relating to the classification of the stocks for user display;
a new portfolio module operable to receive and store new portfolio data relating to a desired new financial portfolio;
a stock evaluation module for storing valuation data relating to an assessment of stocks;
a tactic generator engine operable to access the stock data stored in the stock data store, the new portfolio data stored in the new portfolio module, the valuation data stored in the stock evaluation module, and current market data from financial markets, and operable to perform tactic generating functions on the basis of the stock data, the new portfolio data, the valuation data and current market data to output a set of tactics.

12. Apparatus according to claim 11, wherein the tactic generator is operable to label stock data relating to at least one stock with a tactic tag determined by tactic generating functions, the tactic tag being an identifier of the tactic to be employed in relation to that stock.

13. Apparatus according to claim 11, where in the stock data store is operable to store data relating to the classification attributes of stock other than that held in the financial portfolio.

14. Apparatus according to claim 11, wherein the new portfolio module is associated with an interface through which a user enters the new portfolio data.

15. Apparatus according to claim 12, wherein the new portfolio module is associated with an interface through which a user enters the new portfolio data.

16. A method of converting a financial portfolio strategy into a set of tactics using computerised apparatus, said strategy and tactics relating to the conversion of a financial portfolio comprising stocks into a desired new financial portfolio comprising stocks, said method comprising:
receiving new portfolio data relating to said desired new financial portfolio and valuation data relating to an assessment of stocks;
accessing a financial market for current market data relating to the current performance and availability of stocks being traded in the financial market; and
generating a set of tactics for achieving said desired new financial portfolio on the basis of stock data relating to the stock held in said financial portfolio and classification attributes of the stock, the new portfolio data, the valuation data and the current market data.

17. A method according to claim 16, wherein generating the set of tactics for achieving said desired new financial portfolio comprises:
comparing said desired new financial portfolio against said financial portfolio;
determining which stocks to change in order to achieve said desired new financial portfolio; and
labelling the stocks to be changed with an associated action.

18. A method according to claim 17, wherein labelling the stocks to be changed with an associated action comprises:
determining a rating for each stock to b changed on the basis of the valuation data and current market data; and
labelling each rated stock with a tactic tag, the tactic tag being an identifier of the tactic to be employed in relation to that stock.

19. A method according to claim 18, further comprising:
ordering the labelled stock according to a best first order in each classification of stocks; and
generating a set of tactics for execution from the tactic tags associated with the stocks.

20. A method according to claim 16, wherein prior to receiving new portfolio data relating to said desired new financial portfolio and valuation data relating to an assessment of stocks, said method further comprises:
retrieving the stock data from a stock data store; and
classifying stocks held in the financial portfolio using the stock data to generate classification data relating to the classification of the stocks for user display.

21. A method of converting a financial portfolio strategy into a set of tactics using computerised apparatus, said strategy and tactics relating to the conversion of a financial portfolio comprising stocks into a desired new financial portfolio comprising stocks, said method comprising:
retrieving stock data relating to the stock held in said financial portfolio and classification attributes of the stock from a stock data store;
classifying stocks held in the financial portfolio using the stock data to generate classification data relating to the classification of the stocks for user display;
receiving new portfolio data relating to said desired new financial portfolio and valuation data relating to an assessment of stocks;
accessing a financial market for current market data relating to the current performance and availability of stocks being traded in the financial market; and
generating a set of tactics for achieving said desired new financial portfolio on the basis of the stock data, the new portfolio data, the valuation data and the current market data.

22. A method according to claim 21, wherein generating the set of tactics for achieving said desired new financial portfolio comprises:
comparing said desired new financial portfolio against said financial portfolio;
determining which stocks to change in order to achieve said desired new financial portfolio; and
labelling the stocks to be changed with an associated action.

23. A method according to claim 22, wherein labelling the stocks to be changed with an associated action comprises:
determining a rating for each stock to be changed on the basis of the valuation data and current market data; and
labelling each rated stock with a tactic tag, the tactic tag being an identifier of the tactic to be employed in relation to that stock.

24. A method according to claim 23, further comprising:
ordering the labelled stock according to a best first order in each classification of stocks; and
generating a set of tactics for execution from the tactic tags associated with the stocks.

25. A computer readable storage medium storing instructions that, when executed by a computer, cause the computer to perform a method of converting a financial portfolio strategy into a set of tactics according to claim 16.

26. A computer readable storage medium storing instructions that, when executed by a computer, cause the computer to perform a method of converting a financial portfolio strategy into a set of tactics according to claim 21.
